(19) United States
(12) Patent Application Publication
(10) Pub. No.: US 2024/0067094 A1
(43) Pub. Date: Feb. 29, 2024

(54) GATING CAMERA, VEHICLE SENSING SYSTEM, AND VEHICLE LAMP

(71) Applicant: KOITO MANUFACTURING CO., LTD., Tokyo (JP)

(72) Inventors: Kenichi HOSHI, Shizuoka (JP); Koji ITABA, Shizuoka (JP); Daiki KATO, Shizuoka (JP)

(73) Assignee: KOITO MANUFACTURING CO., LTD., Tokyo (JP)

(21) Appl. No.: 18/269,883

(22) PCT Filed: Dec. 17, 2021
(86) PCT No.: PCT/JP2021/046824

§ 371 Date: Jun. 27, 2023

(30) Foreign Application Priority Data
Dec. 28, 2020 (JP) 2020-218975

(51) Int. Cl. B60R 1/28; B60R 11/04

(52) U.S. Cl. CPC B60R 1/28; B60R 11/04; B60R 2011/0043; B60R 2300/103; B60R 2300/108; B60R 2300/303

(57) ABSTRACT

A gating camera divides a field of view in a depth direction into multiple ranges, and generates multiple slice images that correspond to the multiple ranges. A controller is configured to generate an emission control signal and an exposure control signal. An illumination apparatus emits probe light according to the emission control signal during normal imaging. An image sensor performs exposure according to the exposure control signal. A calibration light source emits calibration light to the image sensor according to the emission control signal during calibration. The controller sweeps a time difference between the emission control signal and the exposure control signal, and monitors a change in a pixel value of the image sensor during the calibration.

### TECHNICAL FIELD

The present disclosure relates to a gating camera.

### BACKGROUND

An object identification system that senses a position and a kind of an object existing in the vicinity of the vehicle is used for autonomous driving or for autonomous control of light distribution of a headlamp. The object identification system includes a sensor and an arithmetic processing device configured to analyze an output of the sensor. The sensor is selected from among cameras, LiDAR (Light Detection and Ranging, Laser Imaging Detection and Ranging), millimeter-wave radars, ultrasonic sonars, and the like, giving consideration to the application, required precision, and cost.

It is not possible to obtain depth information from a typical monocular camera. Accordingly, it is difficult to separate multiple objects at different distances even when the multiple objects overlap.

As a camera capable of acquiring depth information, a TOF camera is known. The time of flight (TOF) camera is configured to project infrared light by a light emitting device, measure the time of flight until reflected light returns to an image sensor, and obtain a TOF image obtained by converting the time of flight into distance information.

As an active sensor instead of the TOF camera, a gating camera (Gating Camera or Gated Camera) has been proposed (Patent Literatures 1 and 2). The gating camera is configured to divide an imaging range into multiple ranges, and to capture an image for each range while changing exposure timing and exposure time. This allows a slice image to be acquired for each target range. Each slice image includes only an object included in the corresponding slice.

With an active sensor such as a distance measurement sensor or a gating camera, there is a need to accurately calibrate a time difference between a light emission timing of a light emitting device and an exposure timing of a light receiving device. Patent Literatures 1 to 3 disclose techniques related to calibration.

### CITATION LIST

### Patent Literature

Patent Literature 1: JP2020-60433A
Patent Literature 2: JP2020-85477A
Patent Literature 3: JP2020-148512A

### SUMMARY OF INVENTION

### Technical Problem

The techniques disclosed in Patent Literatures 1 to 3 are each configured as a ToF sensor assuming that there is hardware for measuring the time of flight. The techniques cannot be applied to a gating camera.

Patent Literature 1 discloses a calibration method for a distance measurement system mounted on a small electronic apparatus. Specifically, the electronic apparatus is placed on a desk or the like, and a surface of the desk is used as a reflector. The application of the technique is limited to a small electronic apparatus, and the technique cannot be applied to a vehicle sensor that does not always have a reflector at the same distance.

In Patent Literature 2, a reflection unit that reflects light emitted from a light emitting unit to a light receiving unit is built into an optical distance measuring device. In the technique, a part of the light emitted from the light emitting unit is shielded by the reflection unit, or only the light reflected from the reflection unit is incident on a part of the light receiving unit. That is, a part of hardware is allocated for calibration, and thus cannot be used during normal imaging, and a part of hardware (or a part of energy) is wasted.

Patent Literature 3 discloses a technique in which a part of light emitted from a light source is incident on an image sensor through a light guide portion and an optical fiber. As in Patent Literature 2, a part of the image sensor is allocated for calibration, and thus cannot be used during the normal imaging, and a part of hardware is wasted.

The present disclosure has been made in view of such a situation, and an exemplary object of an aspect thereof is to provide a gating camera capable of calibration.

### Solution to Problem

An aspect of the present disclosure relates to a gating camera configured to divide a field of view in a depth direction into multiple ranges, and to generate multiple slice images that correspond to the multiple ranges. The gating camera includes a controller configured to generate an emission control signal and a first exposure control signal, an illumination apparatus configured to emit probe light in accordance with the emission control signal during the normal imaging, an image sensor configured to perform exposure in accordance with the first exposure control signal, and a calibration light source configured to emit calibration light to the image sensor in accordance with the emission control signal during calibration. The controller sweeps a time difference between the emission control signal and the first exposure control signal, and acquires a time difference at which a pixel value of the image sensor increases during the calibration.

### Advantageous Effects of Invention

According to an aspect of the present disclosure, calibration of a gating camera is achieved.

### BRIEF DESCRIPTION OF DRAWINGS

FIG. 1 is a block diagram showing a sensing system according to an embodiment.

FIG. 2 is a diagram showing a normal imaging operation of a gating camera.

FIG. 3A and FIG. 3B are diagrams explaining slice images generated by the gating camera.

FIG. 4 is a diagram showing calibration according to Example 1.

FIG. 5 is a diagram showing a relation between a time difference τ and a pixel value Pa of a pixel of interest.

FIG. 6 is a diagram showing calibration according to Example 2.

FIG. 7 is a diagram showing first exposure and second exposure.

FIG. 8A to FIG. 8C are diagrams showing the first exposure and the second exposure.

FIG. 9A and FIG. 9B are block diagrams showing an illumination apparatus and a calibration light source.

FIG. 10 is a block diagram showing the sensing system.

FIG. 11A and FIG. 11B are diagrams showing an automobile provided with the gating camera.

FIG. 12 is a block diagram showing a vehicle lamp provided with the sensing system.

### DESCRIPTION OF EMBODIMENTS

Description will be made regarding a summary of some exemplary embodiments of the present disclosure. The summary is provided as a prelude to the detailed description that will be described later, is intended to simplify the concepts of one or more embodiments for the purpose of basic understanding of the embodiments, and is not intended to limit the scope of the invention or the disclosure. The summary is not an extensive overview of all possible embodiments and is not intended to limit essential components of the embodiments. For convenience, “an embodiment” may be used to refer to a single embodiment (example or modification) or multiple embodiments (example or modification) disclosed in the specification.

A gating camera according to an embodiment divides a field of view in a depth direction into multiple ranges, and generates multiple slice images that correspond to the multiple ranges. A controller sweeps a time difference between the emission control signal and the first exposure control signal, and monitors a change in the pixel value of the image sensor at each time difference during the calibration.

According to the configuration, a timing error can be calibrated in the gating camera having no hardware for measuring a flight time. Furthermore, by preparing a light source for calibration in addition to the light source used during the normal imaging, imaging using all the pixels of the image sensor can be performed during the normal imaging, and the probe light generated by the illumination apparatus is not shielded, and thus waste of hardware can be reduced.

In an embodiment, the controller may acquire a value of a time difference when the pixel value relatively increases.

In an embodiment, the controller may generate a second exposure control signal during a period in which the image sensor cannot detect the calibration light during the calibration. The controller may acquire a time difference in which a value calculated by correcting a pixel value calculated according to the first exposure control signal with a pixel value calculated according to the second exposure control signal increases. Since ambient light can be detected by the second exposure control signal and the influence of the ambient light can be reduced, accuracy of the calibration can be improved. In particular, in the case of a vehicle sensor, the ambient light cannot be blocked during the calibration, and thus the configuration is effective.

In an embodiment, the second exposure control signal may be generated every time the time difference is switched. In a case where the ambient light varies with time, calibration accuracy can be improved.

In an embodiment, the second exposure control signal may be generated as a set with the first exposure control signal. That is, the influence of the ambient light can be further prevented by imaging the ambient light every time the exposure for the purpose of imaging the calibration light is performed.

In an embodiment, the image sensor may be a multi-tap image sensor, and may image using a first tap according to the first exposure control signal and image using a second tap according to the second exposure control signal.

In an embodiment, the illumination apparatus may include a laser diode, and the calibration light source may include a light emitting diode. An increase in cost can be prevented by using the light emitting diode instead of a laser diode as the calibration light source.

In an embodiment, the illumination apparatus and the calibration light source may share a drive circuit.

In an embodiment, the controller may monitor multiple pixel values of the image sensor, and may acquire a time difference for each pixel value. In a case where a timing error exists for each pixel of the image sensor, the time difference for each pixel can be calibrated.

In an embodiment, the controller may monitor a pixel value of a predetermined range of the image sensor, and may acquire a time difference in which the pixel value increases. In a case where the timing error for each pixel is negligible, the method is preferably employed.

In an embodiment, the controller may monitor the multiple pixel values of the image sensor, and may acquire a time difference in which a representative value based on the multiple pixel values increases.

### Embodiments

Hereinafter, preferred embodiments will be described with reference to the drawings. The same or similar components, members, and processes shown in the drawings are denoted by the same reference numerals, and redundant description thereof will be omitted as appropriate. The embodiments have been described for exemplary purposes only, and are by no means intended to limit the disclosure and the invention. Also, it is not necessarily essential for the disclosure and invention that all the features or a combination thereof be provided as described in the embodiments.

### Embodiments

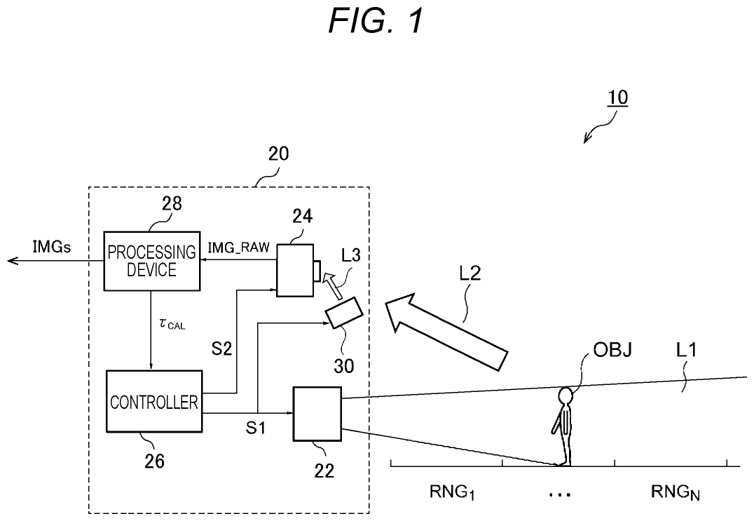

FIG. 1 is a block diagram showing a sensing system 10 according to an embodiment. The sensing system 10 is mounted on a vehicle such as an automobile, a motorcycle, or the like, and detects an object OBJ existing around the vehicle.

The sensing system 10 mainly includes a gating camera 20. The gating camera 20 includes an illumination apparatus 22, an image sensor 24, a controller 26, a processing device 28, and a calibration light source 30. The imaging by the gating camera 20 is performed by dividing afield of view into a plurality of N (N≥2) ranges RNG1 to RNGN in a depth direction. Adjacent ranges may overlap each other in the depth direction at a boundary therebetween.

The sensing system 10 is capable of calibration in addition to normal imaging. First, hardware and functions related to the normal imaging will be described.

The illumination apparatus 22 is used for the normal imaging, and emits probe light L1 in front of the vehicle in synchronization with an emission control signal S1 supplied from the controller 26. As the probe light L1, infrared light is preferably employed. However, the present invention is not restricted to such an arrangement. Also, as the probe light L1, visible light having a predetermined wavelength or ultraviolet light may be employed.

The image sensor 24 includes multiple pixels, is capable of exposure control in synchronization with an exposure control signal S2 supplied from the controller 26, and generates a raw image (RAW image) including the multiple pixels. The image sensor 24 is used for both normal imaging and calibration. The image sensor 24 is sensitive to the same wavelength as that of the probe light L1, and images reflected light (returned light) L2 reflected by the object OBJ. A slice image IMG_RAWᵢ generated by the image sensor 24 with respect to the i-th range RNGᵢ is referred to as a raw image or a primary image as necessary so as to be distinguished from a slice image IMG_{Si} which is a final output of the gating camera 20.

The controller 26 generates the emission control signal S1 and the exposure control signal S2, and controls the emission timing (light emission timing) of the probe light L1 by the illumination apparatus 22 and the exposure timing by the image sensor 24. Specifically, the controller 26 is implemented as a combination of a processor (hardware) such as a central processing unit (CPU), a micro processing unit (MPU), a microcontroller, or the like, and a software program to be executed by the processor (hardware).

The image sensor 24 and the processing device 28 are connected via a serial interface or the like. The processing device 28 receives the raw image IMG_RAWᵢ from the image sensor 24, and generates the slice image IMGsᵢ.

Since the gating camera 20 images reflected light from a far-side object, a sufficient image may not be obtained by single imaging (set of light emission and exposure). Accordingly, the gating camera 20 may repeatedly image N times (N≥2) for each range RNGᵢ. In this case, for one range RNGᵢ, N raw images IMG_RAWᵢ₁ to IMG_RAW_{iN} are generated. The processing device 28 may synthesize the N raw images IMG_RAWᵢ₁ to IMG_RAW_{iN} for one range RNGᵢ to generate one slice image IMGsᵢ.

It should be noted that the controller 26 and the processing device 28 may be configured with the same hardware, and may be implemented, for example, by the combination of the microcontroller and the software program.

The above is the configuration and the function relating to the normal imaging. Next, the normal imaging by the gating camera 20 will be described.

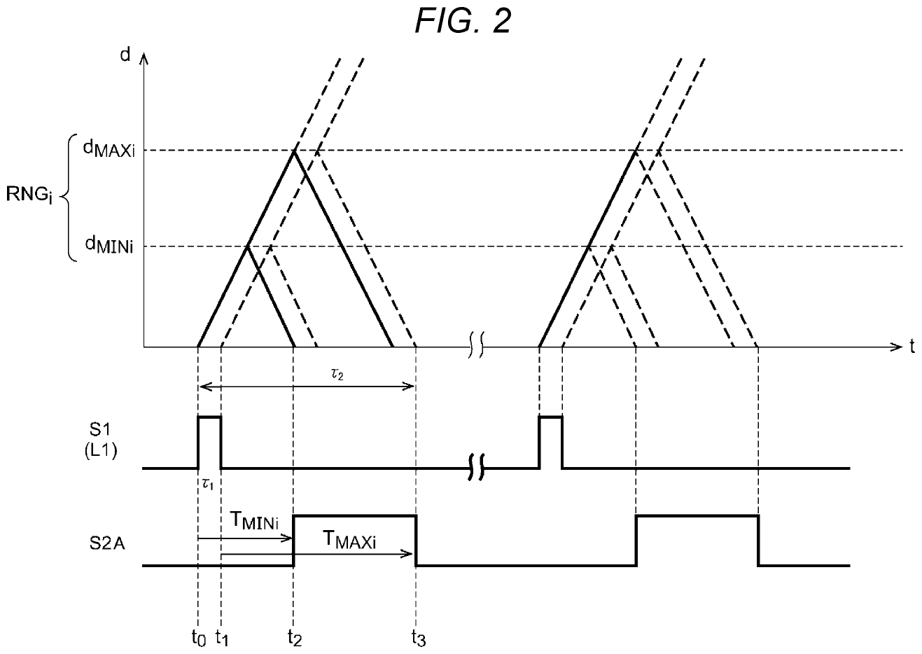

FIG. 2 is a diagram showing a normal imaging operation of the gating camera 20. FIG. 2 shows a state in which the i-th range RNGᵢ is sensed as a range of interest. The illumination apparatus 22 emits light during a light emitting period τ₁ from time points t₀ to t₁ in synchronization with the emission control signal S1. In the upper diagram of FIG. 2, a light beam diagram is shown with the horizontal axis as time and with the vertical axis as distance. A distance between the gating camera 20 and a near-distance boundary of the range RNGᵢ is represented by d_{MINi}, and a distance between the gating camera 20 and a far-distance boundary of the range RNGᵢ is represented by d_{MAXi}.

A round-trip time T_{MINi}, which is a period from the departure of light from the illumination apparatus 22 at a given time point, to the arrival of the light at the distance d_{MINi}, up to the return of the reflected light to the image sensor 24, is represented by T_{MINi}=2×d_{MINi}/c. Here, c represents the speed of light.

Similarly, a round-trip time T_{MAXi}, which is a period from the departure of light from the illumination apparatus 22 at a given time point, to the arrival of the light at the distance d_{MAXi}, up to the return of the reflected light to the image sensor 24, is represented by T_{MAXi}=2×d_{MAXi}/c.

When only an object OBJ included in the range RNGᵢ is imaged, the controller 26 generates the exposure control signal S2 so as to start the exposure at a time point t₂=t₀+T_{MINi}, and so as to end the exposure at a time point t₃=t₁+T_{MAXi}. This is a single exposure operation.

When the i-th range RNGi is imaged, the light emission and exposure may be performed N times. In this case, preferably, the camera controller 26 may repeatedly execute the above exposure operation multiple times with a predetermined period τ₂.

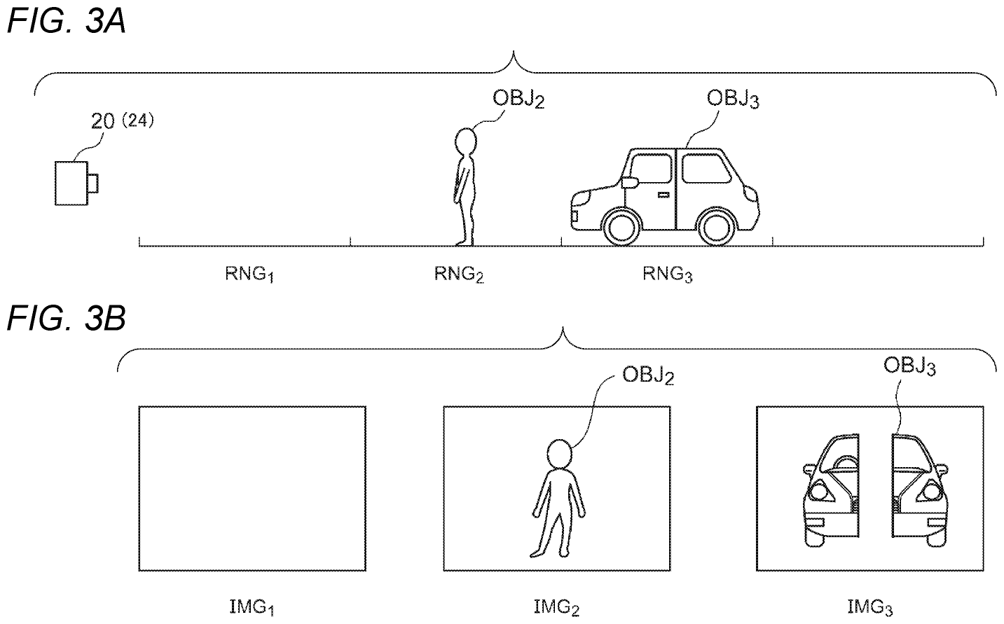

FIG. 3A and FIG. 3B are diagrams explaining slice images generated by the gating camera 20. In an example shown in FIG. 3A, an object (pedestrian) OBJ₂ exists in a range RNG₂, and an object (vehicle) OBJ₃ exists in a range RNG₃. FIG. 3B shows multiple slice images IMG₁ to IMG₃ acquired in the situation shown in FIG. 3A. When the slice image IMG₁ is captured, the image sensor is exposed by only the reflected light from the range RNG₁, and thus the slice image IMG₁ includes no object image.

When the slice image IMG₂ is captured, the image sensor is exposed by only the reflected light from the range RNG₂, and thus the slice image IMG₂ includes only an image of the object OBJ₂. Similarly, when the slice image IMG₃ is captured, the image sensor is exposed by only the reflected light from the range RNG₃, and thus the slice image IMG₃ includes only an image of the object OBJ₃. As described above, with the gating camera 20, an object can be separately imaged for each range.

The above is the normal imaging by the gating camera 20. Next, a configuration and functions related to calibration of the gating camera 20 will be described. Return to FIG. 1. Also, the calibration may be executed with ignition-on as a trigger. The processing may be executed at an arbitrary timing during driving.

The calibration light source 30 is active during calibration, and emits calibration light L3 to the image sensor 24 according to the emission control signal S1 generated by the controller 26.

Description will be made assuming that a difference ΔT between a delay time Ta from the assertion of the emission control signal S1 during the normal imaging until the light emission of the illumination apparatus 22 and a delay time Tb from the assertion of the emission control signal S1 during the calibration until the light emission of the calibration light source 30 is known.

During the calibration, the controller 26 sweeps a time difference τ between the emission control signal S1 and the exposure control signal S2, and monitors a change in the pixel value of one or more pixels (referred to as a “pixel of interest”) of the image sensor 24. For example, the controller 26 acquires a time difference τ_{CAL} when a relatively large pixel value is calculated.

The time difference τ_{CAL} may be determined by the controller 26 or the processing device 28.

Next, a calibration operation will be described based on some embodiments.

### Example 1

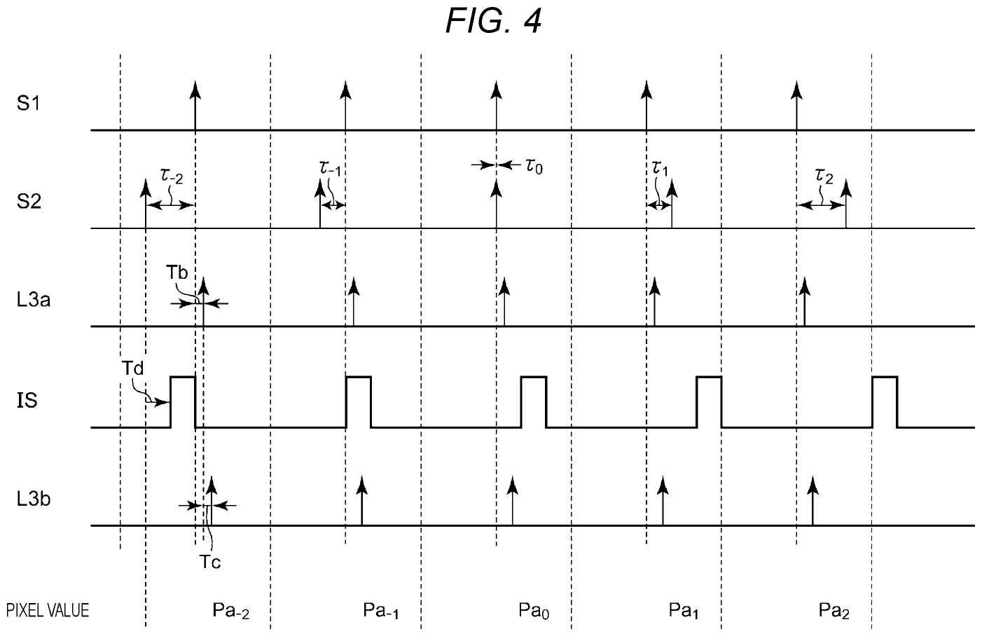

FIG. 4 is a diagram showing calibration according to Example 1.

In Example 1, description will be made focusing on only one pixel (referred to as a “pixel of interest”) among raw images IMG_RAW generated by the image sensor 24.
A position of the pixel of interest is not limited, and may be a center of the image sensor 24.

Here, for simplicity, description will be made assuming that the time difference τ between the emission control signal S1 and the exposure control signal S2 is swept in 5 stages (τ₋₂, τ₋₁, τ₀, τ₁, and τ₂). In practice, the time difference τ can be varied in finer steps with a larger number of steps.

L3a represents a departure time of the calibration light L3 from the calibration light source 30, and L3b represents an arrival time of the calibration light L3 at the image sensor 24. The delay time Tb exists from the assertion of the emission control signal S1 to the light emission timing (departure time) of the calibration light source 30.

There is a propagation delay Tc of the calibration light L3 between the departure time (L3a) and the arrival time (L3b) of the calibration light L3. The propagation delay Tc is determined according to a distance between the calibration light source 30 and the image sensor 24.

IS represents an exposure period of the calibration light source 30. A delay time Td also exists between the assertion of the exposure control signal S2 and the actual start of exposure of the image sensor 24.

If the influence of noise or ambient light is ignored, when the arrival time L3b of the calibration light L3 is outside the exposure period IS of the image sensor 24, a pixel value Pa of the pixel of interest becomes zero. When the arrival time L3b of the calibration light L3 is included in the exposure period IS of the image sensor 24, the pixel value of the pixel of interest Pa increases.

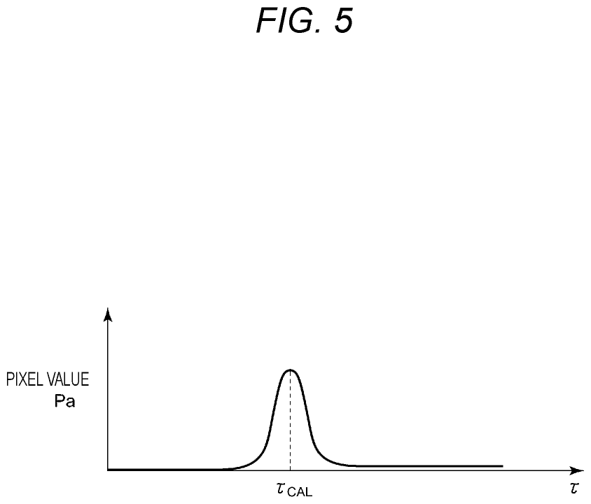

FIG. 5 is a diagram showing a relation between the time difference τ and the pixel value Pa of the pixel of interest. The horizontal axis represents the time difference τ, and the vertical axis represents the pixel value. When the time difference τ is swept, the pixel value Pa of interest increases at a given time difference τ_{CAL} (τ=τ₋₁ in the example of FIG. 4). The controller 26 acquires the time difference τ_{CAL} when the pixel value Pa is relatively large.

The method for determining the time difference τ_{CAL} is not limited in particular. For example, the time difference τ when the pixel value Pa takes the maximum value may be τ_{CAL}. Alternatively, a time difference may be τ_{CAL} when a value calculated by differentiating the pixel value Pa by the time difference τ on the horizontal axis exceeds a predetermined value.

The controller 26 can correct the time difference between the emission control signal S1 and the exposure control signal S2 during the normal imaging using the time difference τ_{CAL}.

As described above, a timing error can be calibrated in the gating camera having no hardware for measuring a flight time. Furthermore, by preparing a light source for calibration in addition to the light source used during the normal imaging, imaging using all the pixels of the image sensor 24 can be performed during the normal imaging, and the probe light L1 generated by the illumination apparatus 22 is not shielded, and thus waste of hardware can be reduced.

### Example 2

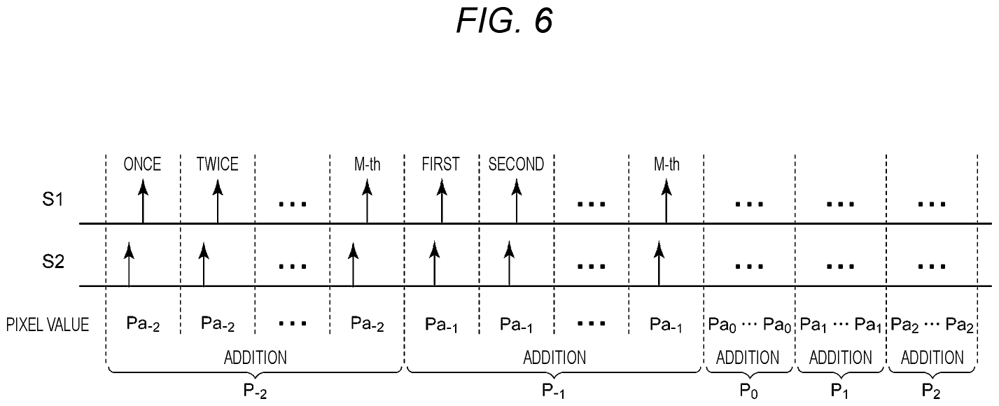

FIG. 6 is a diagram showing calibration according to Example 2. In Example 2, the light emission and the exposure are repeated M times for the same time difference τⱼ (j=−2, −1, 0, 1, 2). As a result, M pixel values Paj are calculated for one time difference τⱼ. The controller 26 acquires the time difference τⱼ when a pixel value Pⱼ calculated by adding or averaging the M pixel values Paⱼ increases.

### Example 3

In the calibration, when the ambient light having a magnitude that cannot be ignored with respect to the calibration light L3 is incident on the image sensor 24, the calibration precision is reduced.

Accordingly, in Example 2, in addition to the exposure (first exposure) for detecting the calibration light L3, exposure (second exposure) for measuring only the ambient light is performed.

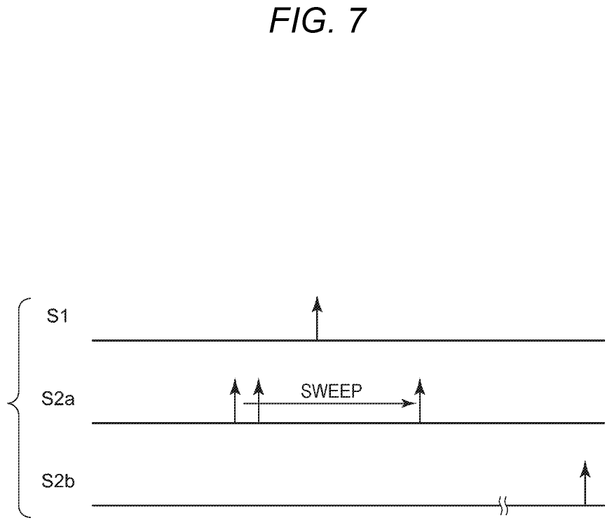

FIG. 7 is a diagram showing the first exposure and the second exposure. The first exposure is executed in a period in which the image sensor 24 is capable of detecting the calibration light L3, and the exposure control signal S2 for the first exposure is referred to as a first exposure control signal S2a. The first exposure control signal S2a is the exposure control signal S2 in Example 1. The second exposure is executed during a period in which the image sensor 24 cannot detect the calibration light L3. The exposure control signal S2 for the second exposure is referred to as a second exposure control signal S2b. That is, the second exposure control signal S2b is asserted at a timing sufficiently far from the emission control signal S1.

The controller 26 (or the processing device 28) corrects the pixel value Pa calculated according to the first exposure control signal S2a with a pixel value Pb calculated according to the second exposure control signal S2b. The controller 26 acquires the time difference τ_{CAL} when the corrected pixel value Pa′ increases. Most simply, Pb may be subtracted from Pa so as to generate the corrected pixel value Pa′ (=Pa−Pb).

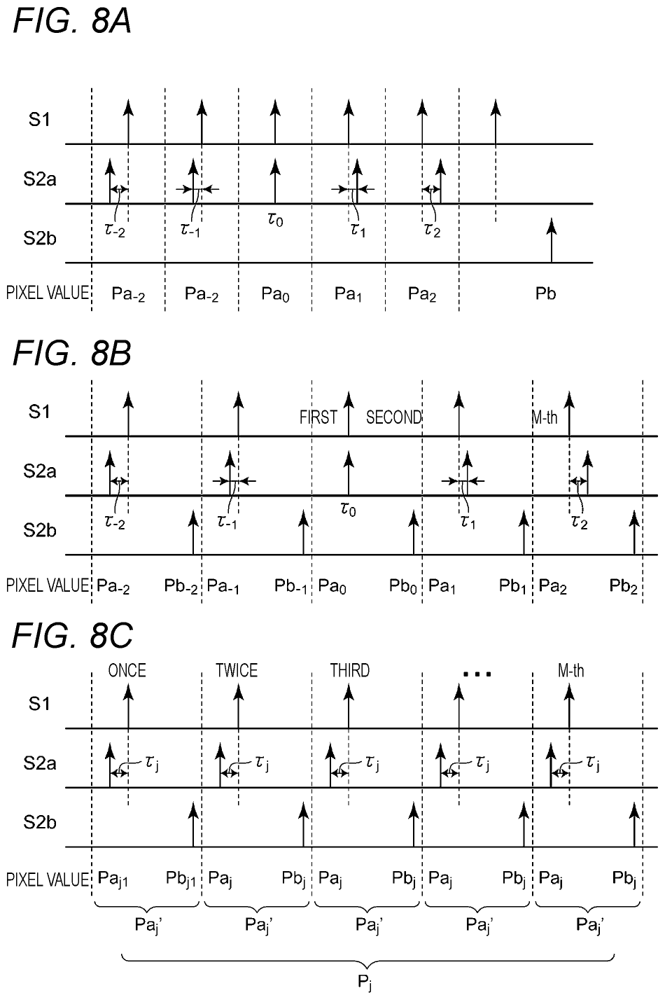

FIG. 8A to FIG. 8C are diagrams showing the first exposure and the second exposure. As shown in FIG. 8A, in a case where the intensity of the ambient light does not change with time, the second exposure may preferably be executed once during one calibration. Pixel values Pa₋₂ to Pa₂ acquired in the first exposure can be corrected using the pixel value Pb acquired in the second exposure. For example, Pb may be subtracted from the Paⱼ so as to calculate the corrected Paⱼ′.

In practice, in many cases, the intensity of the ambient light changes with time.

Therefore, in order to measure the ambient light that changes with time, as shown in FIG. 8B, the second exposure may be executed multiple times during one calibration. For example, the second exposure may preferably be executed for each time difference τ. In this case, for each of the time differences τ₋₂, τ₋₁, τ₀, τ₁, and τ₂, pixel values Pa₋₂, Pa₋₁, Pa₀, Pa₁, and Pa₂ based on the first exposure are calculated, and pixel values Pb₋₂, Pb₋₁, Pb₀, Pb₁, and Pb₂ based on the second exposure are calculated. Assuming that j=−2, −1, 0, 1, and 2, the correction may be executed by subtracting Pbᵢ from a pixel value Paᵢ.

In FIG. 8C, as described in FIG. 6 (Example 2), the first exposure is executed M times for one time difference τⱼ. FIG. 8C shows an operation of one time difference τⱼ.

In this case, the second exposure is preferably executed every time the first exposure is executed. As a result, M Paⱼ and M Pbⱼ are generated. The pixel values Paⱼ are corrected using the corresponding pixel values Pbⱼ, thereby generating M corrected pixel values Paⱼ′. By processing M Paⱼ′, a pixel value Pⱼ is generated. The controller 26 acquires the time difference τⱼ when the pixel value Pⱼ increases.

The image sensor 24 may be a multi-tap CMOS sensor having multiple floating diffusions for each pixel. In this case, the image sensor 24 may be a multi-tap image sensor, and may capture an image using a first tap according to the first exposure control signal S2a and capture an image using a second tap according to the second exposure control signal S2b.

Next, specific configuration examples of the illumination apparatus 22 and the calibration light source 30 will be described.

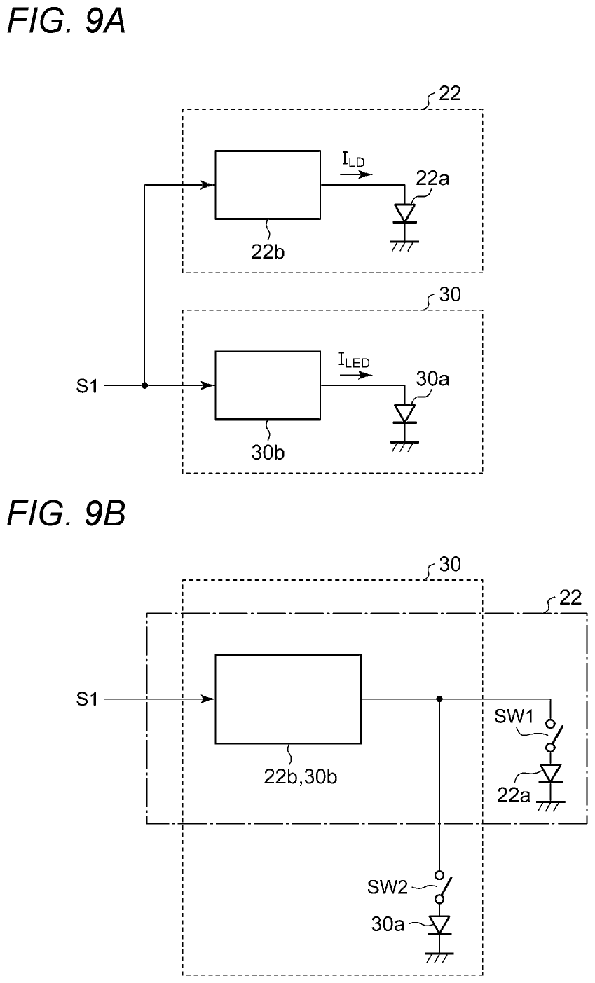

FIG. 9A and FIG. 9B are block diagrams showing the illumination apparatus 22 and the calibration light source 30. In FIG. 9A, the illumination apparatus 22 includes a semiconductor light emitting element 22a and a drive circuit 22b thereof. The semiconductor light emitting element 22a is required to irradiate the far side of the vehicle, and thus a laser diode with high intensity and high directivity is preferably employed. The drive circuit 22b supplies a drive current I_{LD} to the semiconductor light emitting element 22a so as to cause the semiconductor light emitting element 22a to emit pulsed light, in response to the emission control signal S1. The configuration of the drive circuit 22b is not limited in particular, and a known laser driver can be used.

Similarly, the calibration light source 30 includes a semiconductor light emitting element 30a and a drive circuit 30b thereof. The semiconductor light emitting element 30a may preferably irradiate the nearest image sensor 24, and thus such a high output or directivity is not required. Accordingly, a light emitting diode is preferably employed.

It should be noted that a laser diode may be employed as the semiconductor light emitting element 30a.

The drive circuit 30b supplies a drive current I_{LED} to the semiconductor light emitting element 30a so as to cause the semiconductor light emitting element 30a to emit pulsed light, in response to the emission control signal S1. The configuration of the drive circuit 30b is not limited in particular, and a known LED driver can be used.

In FIG. 9B, the illumination apparatus 22 and the calibration light source 30 are configured to share the drive circuits 22b and 30b. In this case, switches SW1 and SW2 may be inserted in series with the semiconductor light emitting elements 22a and 30a, and one of the switches SW1 and SW2 is turned on, and thus the illumination apparatus 22 and the calibration light source 30 may be switched.

The present invention has been described above based on the embodiments. It will be understood by those skilled in the art that the embodiments have been described for exemplary purposes only, and that various modifications can be made to the combinations of the respective components and the respective processing processes, and such modifications are also within the scope of the present invention. Hereinafter, such modifications will be described.

(Modification 1)

In Modification 1, multiple adjacent pixels of the image sensor 24 are set as the pixels of interest. The gating camera 20 may generate a representative value from multiple pixel values, and may acquire the time difference τ_{CAL} when the representative value increases. An average value, a total value, a maximum value, or the like of the multiple pixel values can be used as the representative value.

(Modification 2)

The exposure timing of the image sensor 24 may have an in-plane variation. In this case, multiple pixels of interest may be determined at positions far from the image sensor 24, and for each pixel of interest, the time difference τ_{CAL} may be acquired when the pixel value increases. Accordingly, the in-plane variation of the timing error of the image sensor 24 can be calibrated.

(Application)

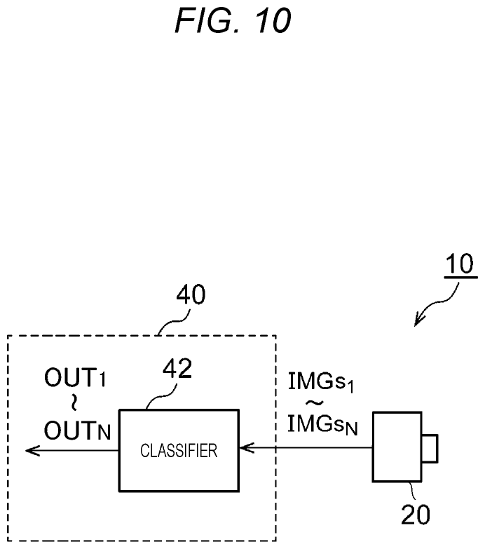

FIG. 10 is a block diagram showing the sensing system 10. The sensing system 10 includes an arithmetic processing device 40 in addition to the gating camera 20 described above. The sensing system 10 is an object detection system mounted on a vehicle such as an automobile, a motorcycle, or the like, and configured to determine the kind (category or class) of an objects OBJ existing around the vehicle.

The gating camera 20 generates multiple slice images IMGs₁ to IMGs_{N} that correspond to the multiple ranges RNG₁ to RNG_{N}. The i-th slice image IMGsᵢ includes only an image of an object included in the corresponding range RNGᵢ.

The arithmetic processing device 40 is configured to identify the kind of an object based on the multiple slice images IMGs₁ to IMGs_{N} that correspond to the multiple ranges RNG₁ to RNG_{N} generated by the gating camera 20. The arithmetic processing device 40 is provided with a classifier 42 implemented based on a learned model generated by machine learning. Also, the arithmetic processing device 40 may include multiple classifiers 42 optimized for the respective ranges. The algorithm of the classifier 42 is not limited in particular. Examples of algorithms that can be employed include You Only Look Once (YOLO), Single Shot MultiBox Detector (SSD), Region-based Convolutional Neural Network (R-CNN), Spatial Pyramid Pooling (SPP net), Faster R-CNN, Deconvolution-SSD (DSSD), Mask RCNN, or the like. Also, other algorithms that will be developed in the future may be employed.

The arithmetic processing device 40 may be implemented as a combination of a processor (hardware) such as a central processing unit (CPU), a micro processing unit (MPU), a microcontroller, or the like, and a software program to be executed by the processor (hardware). Also, the arithmetic processing device 40 may be configured as a combination of multiple processors. Alternatively, the arithmetic processing device 40 may be configured as hardware alone. The functions of the arithmetic processing device 40 and the processing device 28 may be implemented in the same processor.

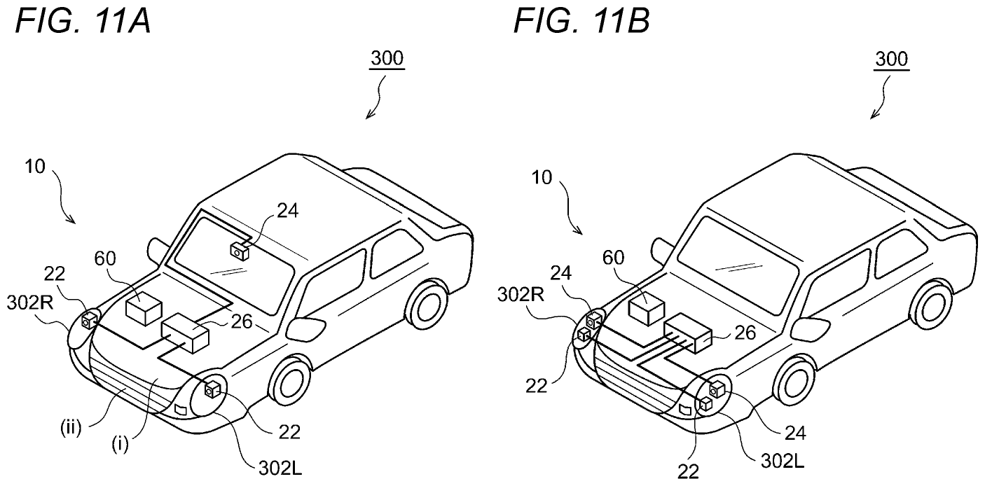

FIG. 11A and FIG. 11B are diagrams showing an automobile 300 provided with the gating camera 20. Referring to FIG. 11A, the automobile 300 includes headlamps (lamps) 302L and 302R.

As shown in FIG. 11A, the illumination apparatus 22 of the gating camera 20 may be built into at least one of the left and right headlamps 302L and 302R. The image sensor 24 may be mounted on a part of a vehicle, for example, on the back side of a rear-view mirror. Alternatively, the image sensor 24 may be provided in a front grille or a front bumper. The controller 26 may be provided in an interior of the vehicle or an engine compartment, and may be built into the headlamps 302L and 302R. The illumination apparatus 22 may be provided at a location other than an interior of the headlamp, for example, in the interior of the vehicle, or in the front bumper or the front grille.

As shown in FIG. 11B, the image sensor 24 may be built into any one of the left and right headlamps 302L and 302R together with the illumination apparatus 22.

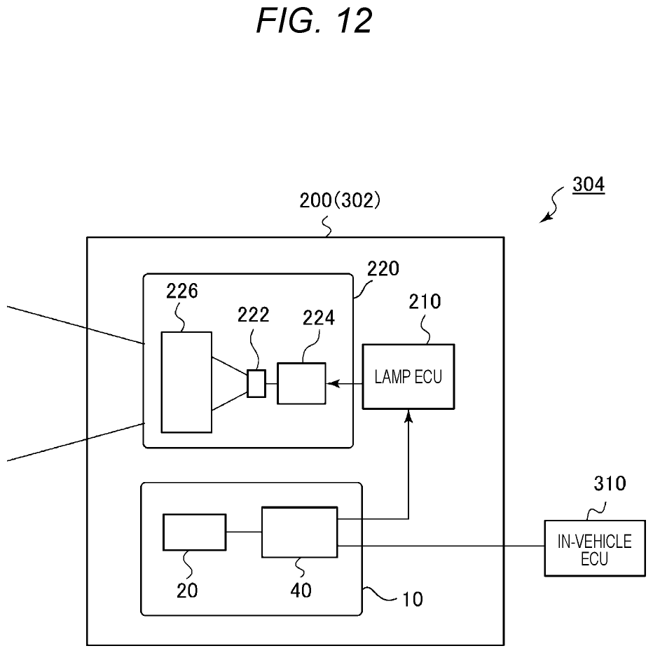

FIG. 12 is a block diagram showing a vehicle lamp 200 provided with the sensing system 10. The vehicle lamp 200 forms a lamp system 304 together with an in-vehicle ECU 310. The vehicle lamp 200 includes a lamp ECU 210 and a lamp unit 220. The lamp unit 220 is a low beam unit or a high beam unit, and includes a light source 222, a lighting circuit 224, and an optical system 226. Furthermore, the vehicle lamp 200 is provided with the sensing system 10.

The information on the object OBJ detected by the sensing system 10 may be used for light distribution control of the vehicle lamp 200. Specifically, the lamp ECU 210 generates a suitable light distribution pattern based on the information on the kind of the object OBJ and a position thereof generated by the sensing system 10. The lighting circuit 224 and the optical system 226 operate so as to provide the light distribution pattern generated by the lamp ECU 210. The arithmetic processing device 40 of the sensing system 10 may be provided outside the vehicle lamp 200, that is, on the vehicle side.

The information on the object OBJ detected by the sensing system 10 may be transmitted to the in-vehicle ECU 310. The in-vehicle ECU 310 may use the information for autonomous driving or driving support.

The embodiments have been described for exemplary purposes only, showing one aspect of the principles and applications of the present invention. Also, many modifications and variations can be made to the embodiments without departing from the spirit of the present invention as defined in the claims.

### INDUSTRIAL APPLICABILITY

The present disclosure can be applied to a sensing technique.

### REFERENCE SIGNS LIST

L1 probe light
S1 emission control signal
L2 reflected light
S2 exposure control signal
S2a first exposure control signal
S2b second exposure control signal
L3 calibration light
10 sensing system
20 gating camera
22 illumination apparatus
24 image sensor
26 controller
28 processing device
30 calibration light source
40 processing device
42 classifier
200 vehicle lamp
210 lamp ECU
220 lamp unit
222 light source
224 lighting circuit
226 optical system
300 automobile
302L headlamp
304 lamp system
310 in-vehicle ECU

1. A gating camera for dividing a field of view in a depth direction into multiple ranges and generating multiple slice images that correspond to the multiple ranges, the gating camera comprising:
a controller configured to generate an emission control signal and a first exposure control signal;
an illumination apparatus configured to emit probe light according to the emission control signal during normal imaging;
an image sensor configured to perform exposure according to the first exposure control signal;
a calibration light source configured to emit calibration light to the image sensor according to the emission control signal during calibration, wherein
the controller sweeps a time difference between the emission control signal and the first exposure control signal during the calibration, and monitors a pixel value of the image sensor at each time difference.

2. The gating camera according to claim 1, wherein
the controller generates a second exposure control signal during a period in which the image sensor is unable to detect the calibration light during the calibration, and
the controller acquires the time difference when a pixel value calculated according to the first exposure control signal is corrected by a pixel value calculated according to the second exposure control signal.

3. The gating camera according to claim 2, wherein
the second exposure control signal is generated every time the time difference is switched.

4. The gating camera according to claim 2, wherein
the second exposure control signal is generated as a set with the first exposure control signal.

5. The gating camera according to claim 2, wherein
the image sensor is a multi-tap image sensor, and captures an image using a first tap according to the first exposure control signal and captures an image using a second tap according to the second exposure control signal.

6. The gating camera according to claim 1, wherein
the illumination apparatus comprises a laser diode, and
the calibration light source comprises a light emitting diode.

7. The gating camera according to claim 1, wherein
the illumination apparatus and the calibration light source share a drive circuit.

8. The gating camera according to claim 1, wherein
the controller monitors multiple pixel values of the image sensor, and acquires a time difference for each pixel value when the pixel value increases.

9. The gating camera according to claim 1, wherein
the controller monitors a pixel value within a predetermined region of the image sensor, and acquires the time difference when the pixel value increases.

10. The gating camera according to claim 1, wherein
the controller monitors multiple pixel values of the image sensor, and acquires the time difference when a representative value based on the multiple pixel values increases.

11. The gating camera according to claim 1, which is mounted on a vehicle.

12. A sensing system for a vehicle, comprising:
the gating camera according to claim 1; and
an arithmetic processing device configured to process the multiple slice images captured by the gating camera.

13. A vehicle lamp comprising the gating camera according to claim 1.
